(19) United States
(12) Patent Application Publication
(10) Pub. No.: US 2009/0109946 A1
(43) Pub. Date: Apr. 30, 2009

(54) Open-Host Wireless Access System

(75) Inventors: David Randolph Morton, Seattle, WA (US); G.R. Konrad Roeder, North Bend, WA (US); Todd Gibson, Rowlett, TX (US)

Correspondence Address: MERCHANT & GOULD PC, P.O. BOX 2903, MINNEAPOLIS, MN, 55402-0903, US

(73) Assignee: T-Mobile, USA, Inc., Bellevue, WA (US)

(21) Appl. No.: 12/347,304

(22) Filed: Dec. 31, 2008

Related U.S. Application Data
(62) Division of application No. 10/951,176, filed on Sep. 27, 2004.

(51) Int. Cl. H04W 4/00

(52) U.S. Cl. 370/338

(57) ABSTRACT

An “open-host” wireless access system includes a wireless access point (AP) that identifies the SSID from a WLAN connection request. A wireless service provider (WSP) is associated with the SSID. The AP is coupled to a demarcation switch within the access system. The demarcation switch includes a series of ports, where one or more ports are associated with a particular WSP. A WSP can connect equipment such as a router to its associated port or ports. The AP opens a VLAN to the designated port or ports to establish connections to the WSPS equipment based on the SSID. The WSP provides IP address assignments and authentication as a native process on the network such that the user experience is customizable by each WSP. Unique login screens and authentication methods can be employed by each WSP.

### FIELD OF THE INVENTION

The present invention relates generally to networking systems. More particularly, the present invention relates to a system and method for providing access to the internet through network access points such as wireless access points.

### BACKGROUND OF THE INVENTION

As society becomes increasingly mobile, mobile electronic devices are enjoying a tidal wave of popularity and growth. Cellular telephones, wireless PDAs, wireless laptops and other mobile communication devices are making impressive inroads with mainstream customers.

Non-portable computers (e.g., desktop personal computers) typically have sophisticated graphics display units and user interfaces (e.g., keyboards) that are convenient for accessing, displaying, and interacting with information. Portable notebook computers also have become popular, sharing similar features with non-portable computers. Many, technologies that were once only available to non-portable computers are now available in portable computers as well as other portable devices. In one example, a mobile telephone includes a display unit that is arranged to display graphical data to support email, web browsing, and other non-voice features. Similarly, a personal data assistant (PDA) device that includes a color display unit may be arranged to similarly display graphical data.

Many mobile electronic devices (e.g., telephones, PDAs, laptop computers) can be configured to access various Local Area Networks (LANs) through a standard type of network interface such as Ethernet. Contemporary mobile device may also include a wireless network interface that allows connection of the mobile electronic device to a wireless local area network (WLAN).

One popular type of WLAN is described in the 802.11 standard from the IEEE (Institute for Electronic and Electrical Engineers). An 802.11 LAN is based on a cell-based architecture, where the system is divided into cell regions that are controlled by a base station, often referred to as an access point (AP). Each device in the 802.11 network is referred to as a station (STA). A collection of stations form a Basic Service Set (BSS), which covers a physical area referred to as a Basic Service Area (BSA). Stations that are outside of the BSA cannot participate in the BSS.

Each station that is participating in a BSS shares common network parameters such as transmit/receive channels, data rates, timer, and service set identified (SSID). Since two BSSs could coincidentally share the same channel, common data rates, and timer, the SSID is used as a unique identifier (e.g., a network name) to differentiate between WLANs. The SSID is a character string up to 32 characters in length (1 to 32-octets) that identifies the BSS (the BSSID). Packets in a BSS, in addition to being addressed from one station to another, also include the BSSID.

There are two kinds of BSSs: an independent BSS (IBSS) and an infrastructure BSS. An IBSS is usually an ad-hoc network such as a peer-to-peer network. An IBSS resembles an Ethernet segment where every station can hear each other, and packets are sent directly to the recipient. In an IBSS, all of the stations are responsible for sending beacons, and the BSSID is generated based upon the STA's MAC address and a randomly generated value. In an infrastructure BSS, there is at least one access point (AP). Each station communicates packets to the AP, where the AP distributes the packets to the intended recipient in the BSS. The BSSID of an infrastructure BSS is the MAC address of the AP's station interface, and the AP is the only station that sends out beacons. The AP is sometimes referred to as the BSS master, while the other stations are referred to as BSS clients.

### SUMMARY OF THE INVENTION

Briefly stated, an “open-host” wireless access system includes a wireless access point (AP) that identifies the SSID from a WLAN connection request. A wireless service provider (WSP) is associated with the SSID. The AP is coupled to a demarcation switch within the access system. The demarcation switch includes a series of ports, where one or more ports are associated with a particular or group of WSPs. A WSP may connect equipment such as a router, bridge or switch to its associated port or ports. The AP opens a VLAN to the designated port or ports to establish connections to the WSPs equipment based on the SSID. Each WSP provides any necessary network or IP address assignments and authentication as a native process on the network such that the user experience is customizable by each WSP. Unique login screens, authentication, access control and encryption methods can be employed independently by each WSP.

A more complete appreciation of the present invention and its improvements can be obtained by reference to the accompanying drawings, which are briefly summarized below, to the following detailed description of illustrative embodiments of the invention, and to the appended claims.

### BRIEF DESCRIPTION OF THE DRAWINGS

FIG. 1 is a diagram illustrating an embodiment of the present invention.

FIG. 2 is a diagram illustrating connection flows for an embodiment of the present invention.

FIG. 3 is a diagram illustrating further connection flows for an embodiment of the present invention.

FIG. 4 is a process flow diagram illustrating connection flows for an embodiment of the present invention.

### DETAILED DESCRIPTION OF THE PREFERRED EMBODIMENT

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The present invention is described in the context of wireless local area network (WLAN) connections between an electronic device and a wireless service provider (WSP) through an “open-host” access system. Although the described embodiments refer to mobile devices, the open-host access system is equally applicable to non-mobile device. Typical mobile and non-mobile devices include: cellular telephones, desktop computers, laptop or notebook computers, personal digital assistants (PDAs), as well as other electronic devices. The use of the term “electronic device” is used to simplify the following discussion, and may be used interchangeably with “mobile device” and “non-mobile device”.

The term “content” can be any information that may be stored in an electronic device. By way of example, and not limitation, content may comprise graphical information, textual information, and any combination of graphical and textual information. Content may be displayable information or auditory information. Displayable information may be viewed on a display unit of the electronic device, while auditory information may comprise a single sound or a stream of sounds that are audible from the electronic device.

Briefly stated, an “open-host” access system includes a wireless access point (AP) that identifies the SSID from a WLAN connection request. A wireless service provider (WSP) is associated with the SSID. The AP is coupled to a demarcation switch within the access system. The demarcation switch includes a series of ports, where one or more ports are associated with a particular WSP. A WSP can connect equipment such as a router to its associated port or ports. The AP opens a VLAN to the designated port or ports to establish connections to the WSP equipment based on the SSID. The WSP provides IP address assignments and authentication as a native process on the network such that the user experience is customizable by each WSP. Unique login screens and authentication methods can be employed by each WSP.

### Example Wireless Access System

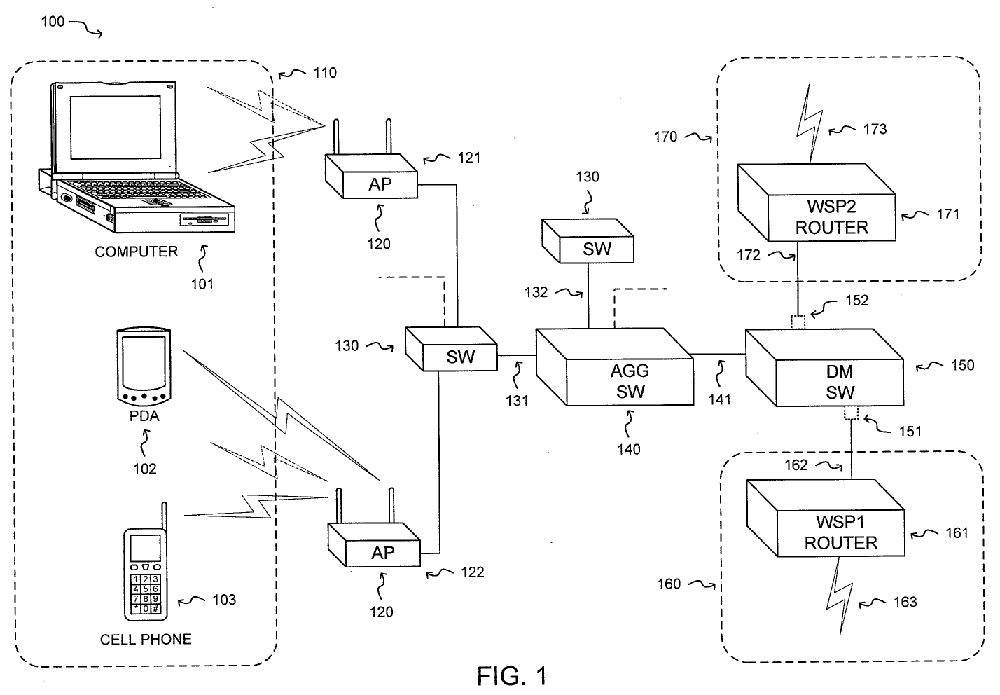

FIG. 1 is a diagram illustrating an embodiment of the present invention. The example embodiment includes two access points (AP 120), two switches (SW 130), an aggregation switch (140), a demarcation switch (DM SW 150), and two sets of wireless service provider (WSP) networking equipment (160, 170).

A first one of the access points (120) is coupled to a first one of the switches (130) through a network connection (121) such as Ethernet. A second one of the access points (120) is coupled to the first switch (130) through another network connection (122). Additional network connections from other access points (not shown) may also be established with either the first switch, the second switch, or some other switch. The switches (SW 130) are coupled to one or more AGG SW 140 through another network connection(s) (131) such as fiber-optic connection (131, 132). The aggregation switch (AGG SW 140) is coupled to the demarcation switch through a high-speed network connection (141) such as fiber optics. The demarcation switch (DM SW 150) includes a first port (151) that is coupled to networking equipment 160, and a second port (152) that is coupled to networking equipment 170.

Each access point (120) can accept WLAN connections from various electronic devices (110) such as computers (101), PDAs (102), and cellular telephones (103). For example, a cellular telephone (103) may be in communication with a first access point over a first WLAN connection (113), a PDA (102) may be in communication with the first access point over a second WLAN connection (112), while a computer (101) may be in communication with the second access point over a third WLAN connection (111). The electronic devices (110) establish communications with their WSP via a virtual LAN connection (VLAN) that is associated with the provider (WSP).

Each electronic device (110) is configured for communication using either a standard method such as IEEE 802.11 (“WI-FI”) and IEEE 802.16, or some other proprietary protocol. Such methods may include authentication methods such as IEEE 802.1X, encryption methods such as IEEE 802.11i as well as communication methods both standard and proprietary such as those defined by IEEE, IETF or other standards and industry organizations.

Each WSP is associated with at least one specified SSID. The SSID is a text-based string that identifies the electronic device as a subscriber or authorized user of the WSP network services. Each electronic device is configured for accessing a network associated with a WSP by initializing the SSID appropriately. For example, a first WSP may have an SSID identifier such as “tmobile”, while another WSP may have an identifier such as “telstra”.

Each AP identifies the SSIDs that are associated with the electronic devices that attempt to establish a WLAN connection. For security reasons, some APs may only accept WLAN connections for one particular WSP, while other APs may accept WLAN connections for multiple WSPs. The SSID is evaluated by the AP to determine if the SSID corresponds to one of the trusted SSIDs. A trusted SSID will be permitted access to network services through a VLAN as will be described, while un-trusted SSIDs will be rejected by the AP. After a trusted SSID is identified by the AP, a logical network connection (a VLAN) is established between the AP (120) and a particular port (e.g., 151) of the demarcation switch (150).

Each SSID can be used to identify a different WSP such that the network traffic is logically separated by the VLAN connections. Although each SSID is mapped to a VLAN, not necessarily every VLAN maps to an SSID. For example, other VLAN connections may be used in a switched portion of the network that is unrelated to the wireless portion of the network.

Although the physical network may be amorphously changed into a larger or smaller collection of network nodes, each VLAN maintains a separate broadcast domain for the connection. Every network segment that is connected to the associated port is effectively part of the VLAN.

The physical routing of the VLAN can be handled over varied network topologies not limited to that illustrated in FIG. 1. For example, a VLAN connection between an access point and a port of the demarcation switch can be routed over another network using topologies such as a VPN tunnel, an IPSEC tunnel, a PPTP tunnel, or a layer 2 transport protocol (L2TP). The system may include a number of aggregation switches and/or demarcation switches such that the network topology can be extended as may be required. In some network implementations, multiple VLAN connections are mapped to the same port of a demarcation switch, while in other network implementations each VLAN is mapped to a single port of a demarcation switch.

In one example, WSP1 has a router (161) that is coupled to port 151 of the demarcation switch (150), while WSP2 has another router (171) that is coupled to port 152 of the demarcation switch (150). A VLAN connection can be established between one of the electronic devices and router 161 by setting the SSID of the electronic device to SSID1, while a connection may be established between with router 171 by setting the SSID of the electronic device to SSID2. Router 161 may be coupled to a distributed network such as the internet via a network connection (163) such as a “T-1” line. Similarly, router 171 may be coupled to the internet or other network via another network connection (173) such as a “DSL”, cable or wireless connection.

Although the example network implementation illustrated in FIG. 1 illustrates port 151 coupled to router 161 and port 152 coupled to router 171, the equipment used by the WSP is not necessarily a router and instead can be any WSP provided equipment that is coupled to the designated port. One or more VLAN connections are mapped to the designated port such that the WSP can handle their own protocol, security, and authentications. Moreover, the particular selection of equipment provided by the WSP at the designated port is not limited by the network structure of the open host system.

Each WSP can handle authentication, authorization, accounting and IP address assignment using different methodologies as may be desired. The user experience with this open host wireless access system can be customized by each WSP such that authentication procedures may be handled differently. In one example, a WSP provides an HTML-style web page (e.g., XML, HTML, and WML) that includes a graphically represented login screen that permits a user to enter a user name and password for authentication. In another example, a WSP queries the electronic device for a MAC address that is registered with the WSP for use in authentication. Any other appropriate authentication procedure may be employed by the WSP.

An example conventional public access WLAN system has a generic login screen that cannot be customized by the WSP, utilizing roaming access on the host network. To start a session, the user that desires access on the WLAN system sets up the SSID on their electronic device for the host system. The electronic device attempts to connect to the WLAN, resulting in a generic login screen that is the provided by the host system. The user enters a login ID, a password, and selects the name of the WSP from the generic login screen. The host system does a proxy with the login data to the WSP for authentication. When authentication is granted, the host system passes limited control over to the WSP for the remainder of the user session. This process may also be automated for the user by employing a software client.

Unlike the present invention, the user interface in a conventional public access system is not customized based on the vendor (the WSP). The present invention employs an open access topology that permits multiple SSIDs to connect to the APs. Each SSID is used to establish a VLAN that originates from the access point to the heart of the network as a logical connection. A user sets their SSID based on their own WSP. The AP receives the connection request, opens a virtual connection down to the router or other network equipment that is identified with the particular WSP (SSID=“tmobile”). The WSP grants an IP address to the electronic device (the “station”) so they can access the network. As soon as the user attempts to open a web page (or email, etc.), the router takes the request over the VLAN network, recognizes that the user has not logged in, and requests authentication. The authentication procedure is customized for each vendor based on the SSID/VLAN connection.

Multiple WSPs can coexist on the same front-end network, where their respective network traffic is logically separated by the VLAN. The access portion of the network can be separated from service portions of the network by the demarcation switch. The access portion of the network may include access points, switches, hubs, aggregation switches, and the demarcation switch. The other side of the ports from the demarcation switch is completely under the control of the WSP such that the demarcation switch forms a physical separation from the WSP networking equipment.

QOS metrics can be used to facilitate load balancing for each AP. Moreover, other traditional load balancing topologies such as round-robin can be used to manage network traffic over the front-end or access portion of the network.

Usage metering can be provided by coupling a metering system to a demarcation switch, or by a customized demarcation switch. Since each WSP is associated with one or more particular ports in the demarcation switch, metering for each WSP can be provided by monitoring the ports of the demarcation switch.

### Example Network Connection Flows

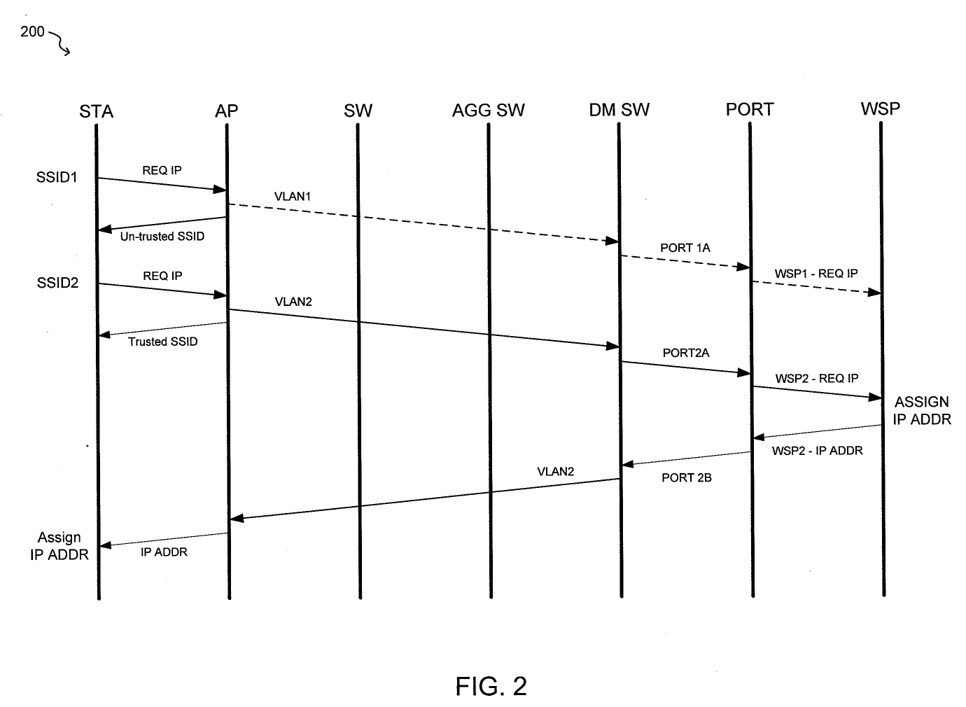

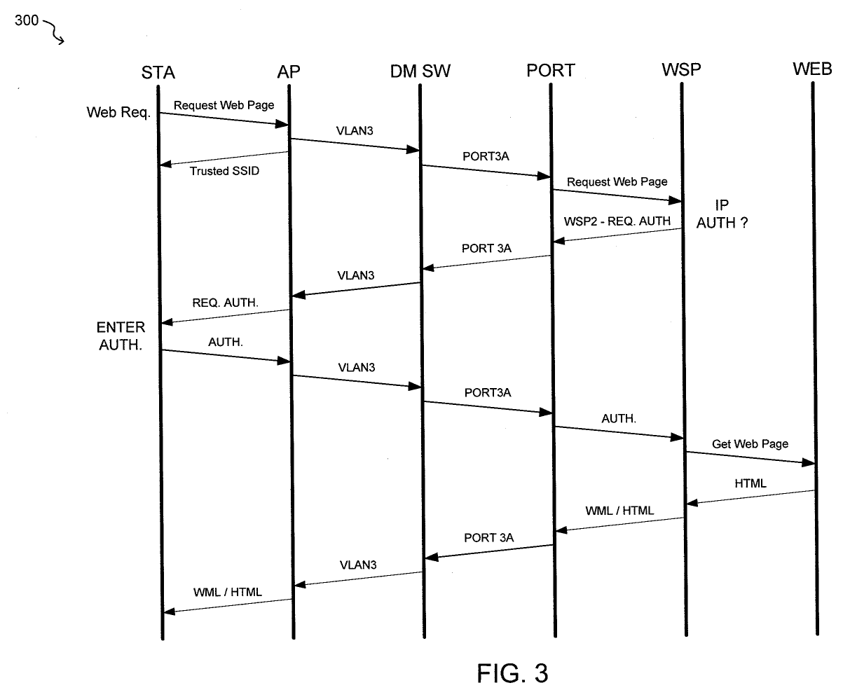

Example connection flows for example embodiments of the present invention will be discussed as follows below with reference to FIG. 2 and FIG. 3.

In FIG. 2, an electronic device (the station or STA) attempts to establish a WLAN with an access point (AP). The electronic device is initialized for an SSID that is designated as SSID1 (e.g., SSID=“telstra”). Connections are attempted by a broadcast message identifying the SSID of the electronic device on a particular channel. Each AP recognizes one or more SSIDs. When a particular SSID is identified by the AP as a valid SSID, the SSID is said to be “trusted”, while unknown SSIDs are “un-trusted”. Connections by un-trusted SSIDs are refused by the AP as illustrated in FIG. 2.

Another electronic device may be initialized for another SSID that is designated as SSID2 (e.g., SSID=“tmobile”). A connection is again attempted by a broadcast message identifying the SSID as SSID2. The AP recognizes SSID as trusted and allows the electronic device to connect. The AP opens a VLAN connection to the designated port number that is associated with SSID as indicated by VLAN2 and PORT2A. In this example, PORT2A and PORT2B are both associated with SSID2 so that two VLANS are used for WSP2.

A request for an IP address (e.g., a DHCP request) is passed over the VLAN connection (VLAN2) to PORT2A, where WSP2 identifies an available IP address and passes the IP address back to the AP over the VLAN connection from PORT2B. The electronic device (STA) receives the assigned IP address from the AP.

In FIG. 3, another electronic device is connected to the access point after the IP address has been assigned with an SSID as designated by SSID3. In this example, the electronic device attempts to access internet-based content (Web Req.) such as, for example, through an internet browser, an email program, or an ftp program. The electronic device communicates with the AP to request the content (e.g., request web page). The request is passed down a VLAN connection (VLAN3) to PORT3A of the demarcation switch, where VLAN3 is associated with SSID3.

WSP3 receives the request from PORT3A and does not recognize the IP address of the electronic device as authorized. WSP3 then sends a request for authentication to the electronic device to VLAN3 through PORT3A. The request for authentication may be provided in the form of web-based content such as a web-page login screen, or some other authentication method. After the user enters the required authentication data (either automatically or manually), the authentication data is sent down to the WSP3 through VLAN3. WSP3 either recognizes the authentication data as valid, or invalid. When the authentication data is validated, the IP address of the electronic device is authorized to access the web through WSP3. Requests for content

Content may be customized by the WSP for a particular type of electronic device. In one example, the WSP provides content from the web as HTML-based web pages. In another example, the WSP receives content from the web as HTML-based web pages, and converts the content to another format such as the wireless markup language (WML).

### Example Process Flow

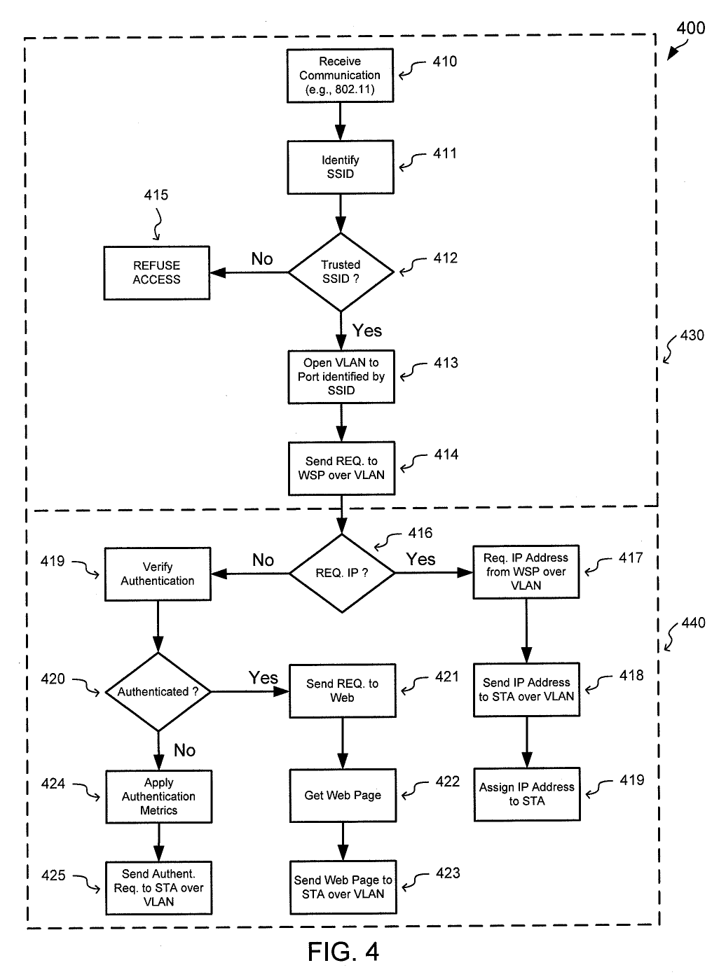

FIG. 4 is a process flow diagram illustrating connection flows for an embodiment of the present invention.

At block 410, the system (e.g., via an AP) receives a communication from an electronic device (e.g. an IEEE 802.11 connection request). Proceeding to block 411, the system identifies the SSID from the communication. At decision block 412, the system determines whether the identified SSID is a trusted SSID or an un-trusted SSID. Processing continues from block 412 to block 413 when the identified SSID is a trusted SSID. Alternatively, processing continues from block 412 to block 415 when the identified SSID is an un-trusted SSID.

At block 413, a VLAN connection is paired with the identified SSID. The VLAN connection forms a logical network connection between the AP and the designated port in the demarcation switch as previously described. Each access point may be capable of handling multiple VLAN connections. In one example, sixteen VLAN/SSID pairs can be handled by an access point. In another example, each AP is configured to handle a single VLAN/SSID pair. Processing continues from block 413 to block 414, where requests from the electronic device communications are forwarded over the VLAN connection to the associated WSP.

Processing continues from block 414 to decision block 416, where the forwarded communication is received by the WSP (e.g., received from the designated port of the demarcation switch). Processing flows from decision block 416 to block 417 when an IP address is either the electronic device requests an IP address, or the electronic device has an IP address that has expired such as under DHCP. Alternatively, processing continues form decision block 416 to block 419 when a valid IP address is associated with the communication.

At block 417, an IP address is requested over the VLAN from the WSP through the assigned port of the demarcation switch. Proceeding to block 418, the WSP provides an IP address that is forwarded to the electronic device (i.e., the STA) over the VLAN. At block 419, the electronic device (the STA) receives the IP address from the access point in a communication, and assigns the IP address to the device.

At block 419, the WSP check (verifies) the authentication associated with the IP address of the request that is received from the assigned port of the demarcation switch. In one example, an authentication string is sent from the electronic device to the WSP over the VLAN that includes a user name and a password. In another example, the authentication string is provided as a MAC address that is associated with the electronic device. Different authentication methods may be used by each WSP, requiring different authentication strings. Processing continues from block 419 to decision block 420 after the authentication procedure is completed.

Decision block 420 evaluates the result of the authentication. Processing continues to block 424 when the IP address associated with the electronic device has not been authenticated. Alternatively, processing continues to block 421 when the IP address associated with the electronic device has already been authenticated.

At block 421, the request from the electronic device is forwarded to a content provider such as a web address on the internet. Continuing to block 422, the content is retrieved (e.g., get web-page) by the WSP and forwarded to the designated port of the demarcation switch. Processing continues from block 422 to block 423, where the retrieved content is provided to the electronic device through the VLAN.

At block 424, authentication metrics are applied to the received communication. Continuing to block 425, a communication is forwarded to the electronic device over the VLAN from the WSP, where the communication includes an authentication request. In one example, the authentication request comprises a customized login screen that requests user name and password entry. In another example, the authentication request comprises a request for a MAC address associated with the electronic device. Any other appropriate method of authentication may be employed as required by the particular WSP.

Processing blocks 410-415 comprise an example of front-end processing (430) for the WLAN that provides access into one or more networks that are handled by different WSPs. As previously described, the front-end/access portion (430) of the network may include access points, switches, hubs, aggregation switches, and the demarcation switch. Each user is configured to access the back-end network that corresponds to a particular WSP by proper initialization of the SSID.

Processing blocks 416-425 comprise an example of back-end processing (440) that is handled by networking equipment from the WSP. As previously described, the back-end portion (440) of the network provides IP addressing and authentication to electronic devices that are coupled to the designated port on the demarcation switch. The WSP networking equipment may include on-site equipment and/or off-site equipment. An example of on-site equipment includes a router and a gateway, while an example of off-site equipment may include a content server that is coupled to the designated port through a communication line such as a T-1 line. Any appropriate equipment may be used at the back-end of the network such that the WSP can customize IP address assignment and authentication.

The systems and methods described above are illustrated with a wireless local area network (WLAN) topology, and with wireless communication that employs the 802.11 communication protocol standard. The described systems and methods are not so limited, and can be configured to accommodate other wireless network topologies such as a wireless wide area network (WWAN), as well as the use of another communication protocol such as the 802.16 standard, or some other proprietary protocol.

The above specification, examples and data provide a complete description of the manufacture and use of the composition of the invention. Since many embodiments of the invention can be made without departing from the spirit and scope of the invention, the invention resides in the claims hereinafter appended.

We claim:

1-40. (canceled)

41. A method for establishing communication between: an electronic device and a wireless service provider (WSP), the method comprising:
receiving a communication request from the electronic device with a wireless access point (AP);
allowing a connection between the wireless access point (AP) and the electronic device when the communication request correctly identifies the wireless service provider (WSP);
refusing the connection between the wireless access point (AP) and the electronic device when the communication request fails to identify the wireless service provider (WSP);
establishing a VLAN between the wireless access point (AP) and a port of a demarcation switch (DM SW) when the connection between the electronic device and the wireless access point (AP) is allowed, wherein the port of the demarcation switch (DM SW) is associated with the wireless service provider (WSP);
sending communications between the electronic device and the wireless service provider (WSP) over the established VLAN.

42. The method of claim 41, wherein sending communications between the electronic device and the wireless service provider (WSP) comprises at least one of:
assigning an IP address to the electronic device through the established VLAN;
authenticating communications between the electronic device and the wireless service provider (WSP) through the established VLAN;
processing a login procedure between the electronic device and the wireless service provider (WSP) through the established VLAN; and
exchanging electronic billing information between the electronic device and the wireless service provider (WSP) through the established VLAN.

43. The method of claim 41, wherein establishing the VLAN between the wireless access point (AP) and the port of the demarcation switch (DM SW) when the connection between the electronic device and the wireless access point (AP) is allowed comprises a least one of:
coupling the access point (AP) to the demarcation switch (DM SW) through an aggregation switch (AGG SW);
coupling the access point (AP) to an aggregation switch (AGG SW) through a network switch (SW);
coupling the access point (AP) to an aggregation switch (AGG SW) through a network switch (SW), where the aggregation switch (AGG SW) is coupled to the demarcation switch (DM SW); and
coupling the access point (AP) to the demarcation switch (DM SW) through a tunnel in a routed network.

44. A method for establishing communication between: a first electronic device and a first wireless service provider (WSP1), and a second electronic device and a second wireless service provider (WSP2), the method comprising:
receiving a first communication request from the electronic device with a wireless access point (AP);
electronic device when the communication request correctly identifies the first wireless service provider (WSP1);
refusing the connection between the wireless access point (AP) and the first electronic device when the communication request fails to identify the first wireless service provider (WSP1);
receiving a second communication request from the second electronic device with the wireless access point (AP);
electronic device when the communication request correctly identifies the second wireless service provider (WSP2);
refusing the connection between the wireless access point (AP) and the second electronic device when the communication request fails to identify the second wireless service provider (WSP2);
establishing connections by at least one of: opening a first VLAN between the wireless access point (AP) and a first port of a demarcation means when the connection between the first electronic device and the wireless access point (AP) is allowed, and opening a second VLAN between the wireless access point (AP) and a second port of the demarcation means when the connection between the second electronic device and the wireless access point (AP) is allowed; and
sending communications between a corresponding one of: the first electronic device and the first wireless service provider (WSP1) over the established first VLAN, and the second electronic device and the second wireless service provider (WSP2) over the established second VLAN.

45. The method of claim 44, wherein sending communications comprises at least one of:
assigning an IP address to through an established VLAN, wherein the established VLAN corresponds to one of the first VLAN and the second VLAN;
authenticating communications between over the established VLAN;
processing a login procedure over the established VLAN; and
exchanging electronic billing information over the established VLAN.

46. The method of claim 44, wherein establishing connections comprises at least one of:
coupling the access point (AP) to the demarcation means through an aggregation switch (AGG SW);
coupling the access point (AP) to an aggregation switch (AGG SW) through a network switch (SW);
coupling the access point (AP) to an aggregation switch (AGG SW) through a network switch (SW), where the aggregation switch (AGG SW) is coupled to the demarcation means; and
coupling the access point (AP) to the demarcation means through a tunnel in a routed network.

47. The method of claim 44, wherein the demarcation means comprises: a demarcation switch (DM SW) that includes the first port and the second port.

48. The method of claim 47, wherein the first port of the demarcation switch (DM SW) corresponds to the second port of the demarcation switch (DM SW) when the first wireless service provider (WSP1) is the same as the second wireless service provider (WSP2).

49. The method of claim 47, wherein the first port of the demarcation switch (DM SW) is different from the second port of the demarcation switch (DM SW) when the first wireless service provider (WSP1) is different from the second wireless service provider (WSP2).

50. The method of claim 44, wherein the demarcation means comprises: a first demarcation switch (DM SW1) that includes the first port, and a second demarcation switch (DM SW2) that includes the second port, wherein the first demarcation switch (DM SW1) is arranged in cooperation with the second demarcation switch (DM SW2).

51. A method for establishing communication between: a first electronic device and a first wireless service provider (WSP1), and a second electronic device and a second wireless service provider (WSP2), the method comprising:
receiving a first communication request from the electronic device with a first wireless access point (AP1);
allowing a first connection between the first wireless access point (AP1) and the first electronic device when the communication request correctly identifies the first wireless service provider (WSP1);
refusing the connection between the first wireless access point (AP1) and the first electronic device when the communication request fails to identify the first wireless service provider (WSP1);
receiving a second communication request from the second electronic device with a second wireless access point (AP2);
allowing a second connection between the second wireless access point (AP2) and the second electronic device when the communication request correctly identifies the second wireless service provider (WSP2);
refusing the connection between the second wireless access point (AP2) and the second electronic device when the communication request fails to identify the second wireless service provider (WSP2);
establishing connections by at least one of: opening a first VLAN between the first wireless access point (AP1) and a first port of a demarcation means when the connection between the first electronic device and the first wireless access point (AP1) is allowed, and opening a second VLAN between the second wireless access point (AP2) and a second port of the demarcation means when the connection between the second electronic device and the second wireless access point (AP2) is allowed; and
sending communications between a corresponding one of: the first electronic device and the first wireless service provider (WSP1) over the established first VLAN, and the second electronic device and the second wireless service provider (WSP2) over the established second VLAN.

52. The method of claim 51, wherein sending communications comprises at least one of:
assigning an IP address to through an established VLAN, wherein the established VLAN corresponds to one of the first VLAN and the second VLAN;
authenticating communications between over the established VLAN;
processing a login procedure over the established VLAN; and
exchanging electronic billing information over the established VLAN.

53. The method of claim 51, wherein establishing connections comprises at least one of:
coupling a respective one of the first and second access points (AP1, AP2) to the demarcation means through at least one aggregation switch (AGG SW);
coupling a respective one of the first and second access points (AP1, AP2) to an aggregation switch (AGG SW) through at least one network switch (SW);
coupling a respective one of the first and second access points (AP1, AP2) to at least one aggregation switch (AGG SW) through a network switch (SW), where the at least one aggregation switch (AGG SW) is coupled to the demarcation means; and
coupling a respective one of the first and second access points (AP1, AP2) to the demarcation means through at least one tunnel in a routed network.

54. The method of claim 51, wherein the demarcation means comprises: a demarcation switch (DM SW) that includes the first port and the second port.

55. The method of claim 54, wherein the first port of the demarcation switch (DM SW) corresponds to the second port of the demarcation switch (DM SW) when the first wireless service provider (WSP1) is the same as the second wireless service provider (WSP2).

56. The method of claim 54, wherein the first port of the demarcation switch (DM SW) is different from the second port of the demarcation switch (DM SW) when the first wireless service provider (WSP1) is different from the second wireless service provider (WSP2).

57. The method of claim 51, wherein the demarcation means comprises: a first demarcation switch (DM SW1) that includes the first port, and a second demarcation switch (DM SW2) that includes the second port, wherein the first demarcation switch (DM SW1) is arranged in cooperation with the second demarcation switch (DM SW2).
